(19) United States
(12) Patent Application Publication
(10) Pub. No.: US 2010/0153008 A1
(43) Pub. Date: Jun. 17, 2010

(54) METHOD AND SYSTEM TO ENHANCE SITE PROMOTION USING LOCATION INFORMATION AND INCENTIVE DISTRIBUTION

(76) Inventors: Mark H. SCHWARTZ, Livonia, MI (US); Nilesh V. PATEL, Novi, MI (US); Kent PU, San Diego, CA (US)

Correspondence Address: HARNESS, DICKEY & PIERCE, P.L.C., P.O. BOX 828, BLOOMFIELD HILLS, MI, 48303, US

(21) Appl. No.: 12/332,610

(22) Filed: Dec. 11, 2008

(51) Int. Cl. G06Q 30/00; G01C 21/20; G06Q 20/00

(52) U.S. Cl. 701/207; 701/213; 705/14.27

(57) ABSTRACT

An improved method for physical site promotion is provided. The method includes capturing personal user preferences; determining time of day and current geographic location of the user, and then based also upon the projected travel route—making recommendations based for intermediate stops, which make available significant discounts and savings to the user for accepting the promotional offers at the recommended stop locations. A computer program product which incorporates this method increases effectiveness of advertising of physical retail and attraction sites beyond conventional means. Benefits are widespread as coupon publisher benefits through reduction in paper based publication costs, retailer experiences increased usage of promotional products, and the user enjoys limits on their cost of system operation by distribution of savings between the user and the system provider.

### FIELD

This disclosure relates to systems and methods for facilitating the promotion of retail business locations by offering of discounts on products for sale. It also relates to usage of navigation systems for improving the effectiveness promotional offers.

### BACKGROUND

The statements in this section merely provide background information related to the present disclosure and may not constitute prior art.

### Need for Maximizing Travel Efficiency

The cost of travel in terms of both fuel and time has reached such high levels that it has already impacted the decision of drivers to even make a trip. Combustible fuel costs are only expected to increase in the future because they are based on a non-renewable resource. Cost of time spent during travel is also related to density of travelers and number of roads. Because population shifts to metropolitan areas are increasing faster than roads can be built, density of vehicle traffic will only become worse. There therefore exists a need for new tools to assist drivers in becoming more efficient in route planning and navigation.

Computerization has improved the productivity of most areas of business. In terms of route planning and navigation, internet based services such as www.mapquest.com and http://maps.yahoo.com/ can determine the turn-by-turn directions to a selected destination from a predetermined starting point. Likewise portable global positioning systems (GPS) based navigation systems can direct a traveler to a selected address in real-time. However, the promise of the ideal navigation aide is still unrealized. Route planning remains cumbersome by requiring pre-planning from the user either in an offline fashion to do searching based on estimated itinerary, while portable navigation units are limited in their usefulness because they only can identify a relatively small number of alternative shopping locations and do not make personalized suggestions.

### Prior Art in Portable Navigation

Despite technological advances afforded by internet route planning, computerized business search engines or electronic yellow pages searching, and portable GPS, several critical weaknesses remain in targeting location of merchants using personal navigation tools. One solution has been to add easy search capabilities to internet based trip planning and mapping software in order to allow a user to add destinations conveniently located along a trip route while still in the planning stages. Another approach has been for personal navigation systems to contain points of interest such a restaurants, gas station locations and banks. But, in actuality, there is no current system which combines the ability to navigate in real-time along with the ability to provide personalized and detailed dining and retail shopping information.

Currently, the most common form of navigation systems for travel include on-board navigation services based on two-way communication such as OnStar Information Services Option, or built-in or personal GPS systems. However, for a driver not on a trip out of familiar territory, navigation is required less than 5% of the average driving cycle. As a result, GPS is not useful most of the time. GPS units are typically used for route planning at a fraction of their potential.

### Need for Effective Advertising Methods

Internet based businesses have put a significant hurt on the sales made in conventional “brick and mortar” retail locations. In order to make up for loss of sales to internet based businesses, and also giant mega-stores such as Costco and Wal-Mart, conventional retailers are looking for ways to actually leverage the increasing cost of fuel and vehicle maintenance. Consumers are increasingly willing to adopt technological means to decrease their costs. Influence of new technologies on customer spending habits is evidenced by the decrease in sales of hard copies of music or CD's by strictly electronic or MP3 based formats. Likewise consumers are less willing to pay for hard copy magazine and newspaper subscriptions and are becoming accustomed to not paying for this print content as they download identical but free electronic copies over the internet. As volume of “snail mail” goes down, the per piece price goes up and the cost of mailed advertising is escalating. Retail advertisers are therefore looking for new and more efficient ways to pull customers to their locations.

### Prior Art in Incentive Based Marketing

Probably the most prevalent means to attract customers to a particular product or retail establishment has been through specific sales coupons. However the ubiquity of this promotion has also become one of its weaknesses. This is because the massive amount of disparate types of coupons which come in the mail, through newspapers, inserts and via email has become overwhelming to organize by consumers. Taking advantage of these discounts requires organizing them in one location, filing them for quick access, noting pertinent expirations and then recalling the coupon's existence in order to use them within the expiration window. These factors have led prior inventors to try to surmount these problems for example by improving the actual filing of the coupons or associating the coupons automatically with a shopping list.

Another solution that has proven attractive to retailers is to avail themselves of relatively low cost advertising in coupon books. One business model in this case is for the retail operation to not pay upfront for listing in the publication but for the customer to in effect pay for the publishing costs by purchase of the coupon book. The cost of the book to the user is made low enough that realization of a small fraction of the potential savings in the publication more than recoups the initial upfront cost to the user. However, as effective as this promotional means has proven to be, it is losing favor with many users as the more personalized services offered by internet applications become more commonplace. Also, the fact that coupons are so frequently available at no cost over the internet has decreased the willingness of users to make expenditure in advance for purchasing these coupon books.

FIG. 1 illustrates a functional overview of the processing procedures that are typically involved in the use of paper based coupons as sent in the mail, from a coupon book, or downloaded from the internet for travel dining. In particular, the finding of a pertinent discount and the obtaining of directions to the geographic location of the selected establishment are manual and time consuming processes that suffer because of their tedious and repetitive nature. The location and routing to the selected site must be manually determined. Even if a GPS unit is used to plot the route, the address information for the site would have to be manually entered into that unit.

FIG. 2 illustrates a functional overview of the processing procedures that are typically involved in the planning of a trip using conventional trip planning methods and tools. These methods are in effect similar to route planning using conventional portable GPS systems. In order to add a side trip to the route planned or in order to find discounts along the route would have to be a very complex and iterative process requiring at best having multiple yellow page type look ups based on zip code or city name, looking up for a type of business in that zip code or city, and then looking to see if that business provided any coupons on their website. This would also be a low percentage exercise. The user either looks online for discounts and then searches for locations that honor or redeem those discounts in the general vicinity of the trip route. Alternatively, the user reverses the order of these steps and first locates desired shopping sites and then tries to determine if desirable discounts are available at those site locations. Once the site locations are determined and the discount coupons are printed out, the user needs to verify the hours of operation and then use either hard copy maps or online mapping services to plot a route to that location.

However, all of the above mentioned systems are deficient in their ability to serve as a platform to expedite promotion based sales and purchases for both users and advertising merchants. Conventional GPS devices have a large but limited number of preprogrammed locations in their internal database. There are no potential sources of added value to the user and therefore no information much less incentive exists for the user to seek out one location versus another except based on proximity. Moreover, the usefulness of these location entries in the site database diminishes as their number increase without a means to search them based on advanced criteria and personalized user preferences. Even in the instance of the user performing the route planning using online mapping software, the overall results are currently limited by the accuracy with which the user during travel does not deviate from the previously determined route.

None of the above mentioned systems are able to drive users to a retail location preferentially over an equally favorably located site. Coupon books do not have the physical means to facilitate the finding of appropriate locations much less automatically suggest such sites in real-time based on personal user preferences. Moreover, none of these systems have means to provide financial rewards as a motivational tool in a way that helps defray the cost of obtaining the system to the user and system purchaser, and do not provide means to reward the merchant for participating in the coupon incentive program. Finally, no existing methods or systems provide means to intelligently provide additional promotions and coupons to a user based on knowledge of their previous purchasing habits.

### SUMMARY

The present disclosure introduces a new method to enhance site promotion using location information and incentive distribution. The system which expedites this method is termed for brevity the enhanced location information for site promotion (ELISP) system. The ELISP method and system provide intelligent travel guide assistance for travel decision making which by virtue of being integrated with GPS based hardware use location, route planning, and user preferences, maximizes the number of visits to desired locations, while minimizing the time spent by the user in manually searching and planning an equally efficient and financially rewarding route thereby better and preferentially driving customers to physical site locations by employ of promotional incentives

Based on the user preferences for location types and current location information, the user preferences on times for various activities and current time information, or alternatively upon direct user request, the intelligent travel guide decision making is performed and thereby creates and displays a list of suggestions for alternative stop locations. Once the intelligent travel guide process identifies possible stop locations a selection process forms a shortened subset of optimum alternatives for maximizing the user savings within the constraints of the user preferences. The intelligent travel guide process further takes the extracted alternatives and organizes these selected sites in a ranked order summary as a list for display to the user; solicits the users site selection; based on the users selection displays the discount coupon; and permits the merchant at the selected site to erase the coupon; and then performs the synchronization with a remote server to permit accounting for incentive sharing. The method can include means to keep track of overall savings using the device so that the user can fully appreciate the advantages of utilization in terms of dollar and percentage savings among others.

Accordingly, a method for trip navigation is provided which minimizes the burden of effort upon the user while maximizing the financial savings which can be realized during the trip. The method includes means to perform distribution of incentive savings between the user and the system provider. By virtue of the incentive distribution process of the present invention, the user can actually realize sufficient savings to help pay for the use of the real-time navigation capability included within ELISP or a way to acquire the hardware of the system at lowest possible or even no cost to the user.

The ELISP system consists of: (1) intelligent travel guide module, (2) location and routing module, (3) user preference database, (4) point of interest database, (5) site information database, (6) device ID, (7) hash computing module, (8) rendering module, (9) incentive utilization module, and (10) external interface module. In other features, an update of the site information database, point of interest database, or even user preference database can be performed by synchronization to the remote central system server through an internet connection supported by the external interface module. If desired these components may be embodied in a handheld device that functions as an electronic coupon apparatus. The ELISP system can also include a printing device that makes a hardcopy duplicate of the coupon for provision to the redeeming merchant. In alternative embodiments, the digital display can provide a barcode image of sufficient size, clarity and brightness to facilitate scanning by a merchant's barcode reader which can serve instead of a hardcopy coupon printout. In yet others, a wireless connection such as Bluetooth can be used to communicate and transmit an electronic version of the coupon to a cell phone for display or electronic redemption or a device owned by the merchant, which can automatically receive unique coupon information for secure redemption.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 shows a functional overview of the processing procedures that are typically involved in the use of a paper based coupons and coupon books according to the prior art.

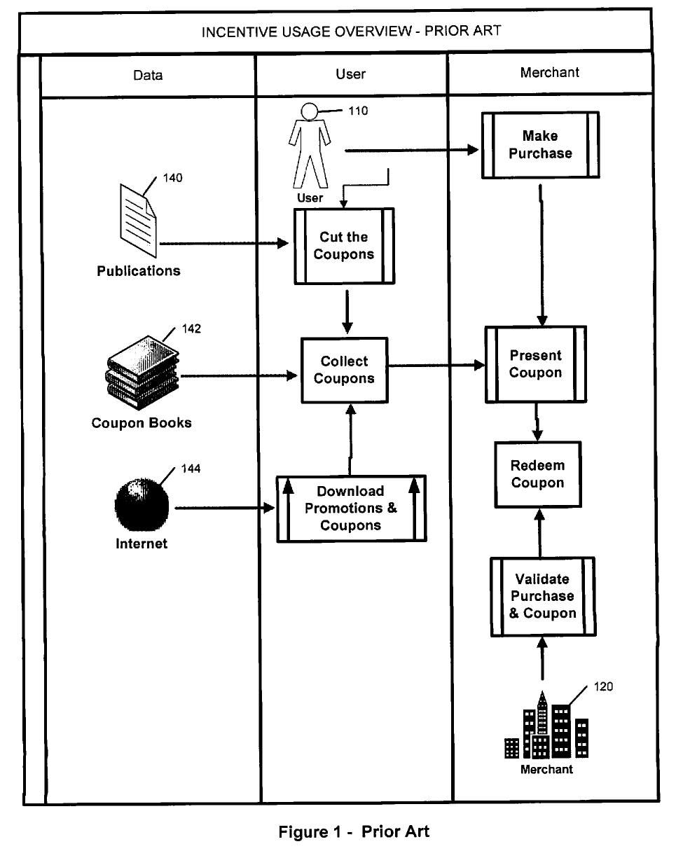

FIG. 2a shows a functional overview of the processing procedures that are typically involved in using a printed coupon book to plan a shopping trip according to the prior art.

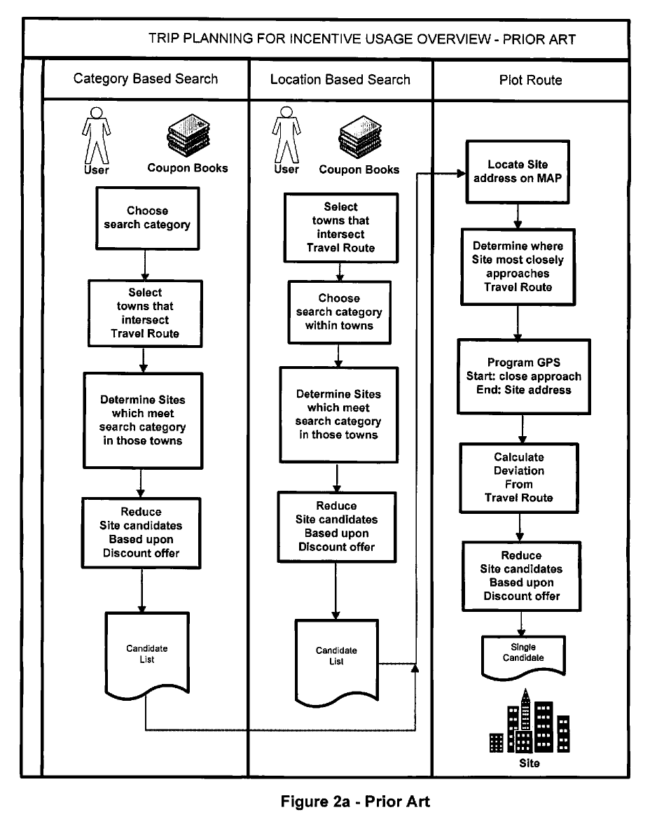

FIG. 2b is a flowchart illustrating a method of using conventional GPS or mapping software in combination with typical means for locating discounts in planning a shopping trip according to the prior art.

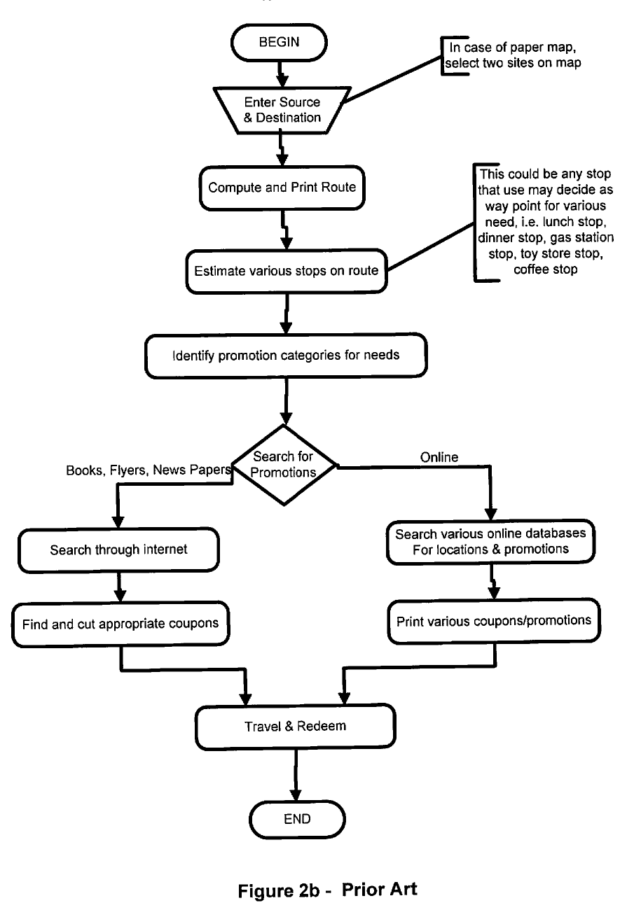

FIG. 3 is a block diagram illustrating a system to enhance site promotion using location information and incentive distribution according to various aspects of the present disclosure.

FIG. 4 is a flowchart illustrating a method of system setup to create the personal preferences database according to various aspects of the present disclosure.

FIG. 5 is a flowchart illustrating a method of site selection within an enhanced site promotion environment according to various aspects of the present disclosure.

FIG. 6 is a flowchart illustrating a method of site discount redemption within an enhanced site promotion environment according to various aspects of the present disclosure.

FIG. 7 is a high level diagram illustrating an exemplary process flow for usage of the system to enhance site promotion using location information and incentive distribution within a road trip environment according to various aspects of the present disclosure.

FIG. 8 shows an exemplary site information database file which assists in generating site recommendations according to various aspects of the present disclosure.

FIG. 9 shows an exemplary predetermined preferences database file which assists in generating site recommendations according to various aspects of the present disclosure.

FIG. 10 is a flowchart illustrating a method of system setup to create the site information database according to various aspects of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The following discussion assumes the reader is familiar with promotional advertising concepts, discount coupon books, normal business practices for handling retail sales, GPS software, personal computer hardware, portable wireless communications, and point of sale systems.

Without the deficiencies of prior art, the present invention can be advantageous to highly mobile travelers and tourists on business trips and vacations. This population is motivated to achieve peace of mind while driving in unfamiliar territories and most capable of using new technological tools to reduce shopping and dining expenses, speed location of accommodations, and maximize logistical efficiencies. Various embodiments provide for a novel navigation system that through its new and unique combination of software and hardware significantly increases the ability of a traveler to geographically locate the most desirable suppliers of a product or service and other significant feature improvements for key driving and shopping situations. These capabilities enable the usage of the invention much more frequently, resulting in customer savings both through promotional pricing on purchases and lowered fuel consumption.

As can be appreciated, the method and system of the enhanced site promotion using location information and incentive distribution are applicable to various site promotion systems including, but not limited to, restaurants, fast food establishments, and retail stores. Essentially all kinds of retailers and service providers can make use of the invention to promote their particular business. Although the methods and systems are applicable to various promotional systems and can run on various hardware apparatuses including cell phones and portable digital assistant devices, for ease of the discussion, the remainder of the disclosure will be discussed in the context of portable navigation systems.

The present disclosure describes various embodiments of a system and method to enhance site promotion using location information and incentive distribution. In all its various embodiments an ELISP system 100 performs navigation for maximum savings while minimizing efforts from the user. The ELISP system 100 can be implemented within a single computer or be distributed over a number of devices. Various software modules, data structures, and processes for performing enhanced site promotion are encapsulated within the ELISP system 100.

An exemplary ELISP system may include: (1) intelligent travel guide module, (2) location and routing module, (3) user preference database, (4) point of interest database, (5) site information database, (6) device ID, (7) hash computing module, (8) rendering module, (9) incentive utilization module, and (10) external interface module. It is appreciated that the modules and data structures shown may be combined and/or further partitioned to similarly perform enhanced site promotion. Various embodiments of site promotion methods and systems include alternative implementations and combinations of the above described elements as will be described in more detail below.

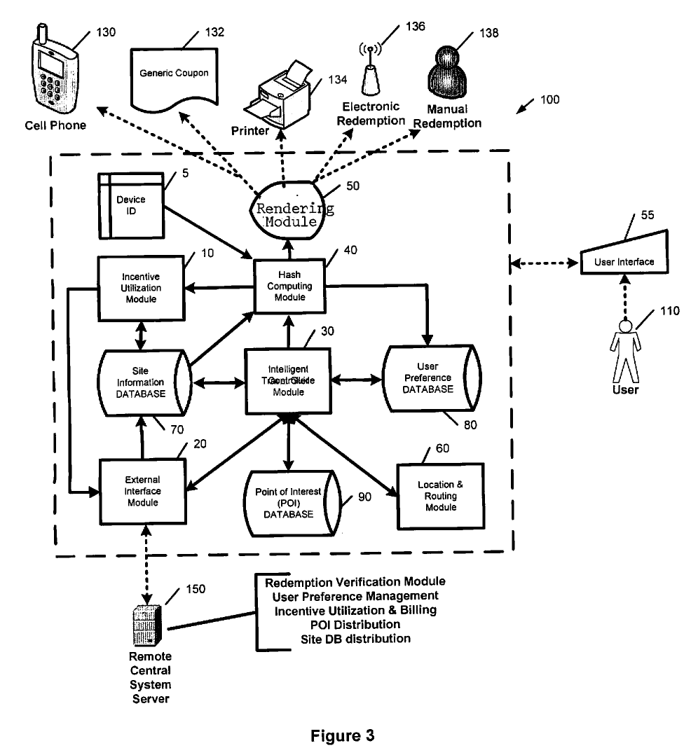

For the sake of simplicity of description, an exemplary ELISP system is shown in FIG. 3. The arrows in FIG. 3 show flow of communications between the modules. The user interface module 55 serves for configuration, data input, and control of operation of the ELISP system 100. The user interface module 55 can be used to create the user preference database 80 or this database can be created externally to the ELISP system 100 and uploaded to it through the external interface module 20 or loaded into a micro-chip memory storage device and plugged directly into the ELISP system 100. The site information database 70 contains site information compatible and supportive of searching for user preferences in terms of types of parameters including time for meals, types of cuisine for each meal, importance of discounts, and price range. It is created externally to the system of the invention in preferably by the company that gathers site promotions for example the types of company that creates coupon book such as Entertainment Publications Inc. In normal usage operations, user interface module 55 is used to acquire end destination location. The location and routing module 60 calculates the route to reach that location based on minimum estimated time. This is similar to conventional GPS systems, however based on previous configuration which sets values in the predetermined user preferences database 80 the intelligent travel guide module 30 searches the site information database 70 for locations which meet the previously established preferences of distance and kind which are positioned within the preferred limits of the projected route as calculated by the location and routing module 60.

The user can elect to operate the electronic coupon apparatus a browse mode in which the location, date/time and other user preferences may be used to query the associated databases. In this way the user can explore what coupons are potentially available for presentment. In the browse mode a coupon that is only redeemable at a certain location at a certain date and time may nevertheless be viewed, even if the user is not currently at that location and even if the redemption date and time has not arrived. In other words, even coupons that are not yet available for presentment can still be viewed in the browse mode.

Once suitable site location matches are found and they are within the permissible radius of departure from the planned route, the sites of interest are ranked and displayed to the user 110. The list of sites is found and can be sorted by the intelligent travel guide module 30 in terms of savings, kind, or distance of departure from the route.

Once the user 110 selects a particular discount to be redeemed, the rendering module 50 displays the coupon to be redeemed and guides the user 110 through turn-by-turn directions to that location. Once at that location, when the user 110 is ready to make a purchase, the site location manager or the merchant 120 can view the coupon and follow steps to redeem its value. In various embodiments, a unique device identification (ID) 5 is read by a hash computing module 40 and the device ID 5 along with the coupon value and site location ID located in the site information database 70, and time stamp information are incorporated in the coupon ID generated by the hash computing module 40 in order to prevent electronic forgery of the coupons.

The electronic coupon apparatus includes a presentment mediation system that marks coupons as having been presented or “spent”, at the election of the merchant at the time of presentment. The mediation system thus alters the hash code associated with the coupon so that it cannot be used again. In performing its mediation function, the presentment mediation system accesses the databases to enforce rules whereby redemption of a particular coupon can be inhibited based on location and date/time attributes. For example, when in presentment mode, the mediation system will block or inhibit a coupon from going through the presentment phase if the current location does not match the designated location within the coupon data. Similarly, the mediation system will block or inhibit a coupon from going through the presentment phase if the current date and/or time (date/time) does match the date/time attributes for that coupon as stored in the database.

Also as shown in FIG. 3, the external interface module 20 can be used to permit the ELISP system 100 to communicate with the remote central server 150. This communications permits for the log file of redeemed coupons to be uploaded to the remote central server 150 for accounting and tracking purposes on a demand or scheduled basis. This tracking of incentives supports the business model whereby based on results from the incentive utilization module, the incentive distribution module contained within the remote central server 150 calculates the savings to be distributed among the user 110, the merchant 120, and the server/system provider when using a particular coupon in a transaction. This financial distribution of savings value between participating parties serves to encourage use of the ELISP system 100 and make it successful by decreasing the cost of hardware to the user, and compensating the merchant for effort spent in accepting the coupons, and partially reimburses the merchant for the cost of the discount offered by the coupon itself.

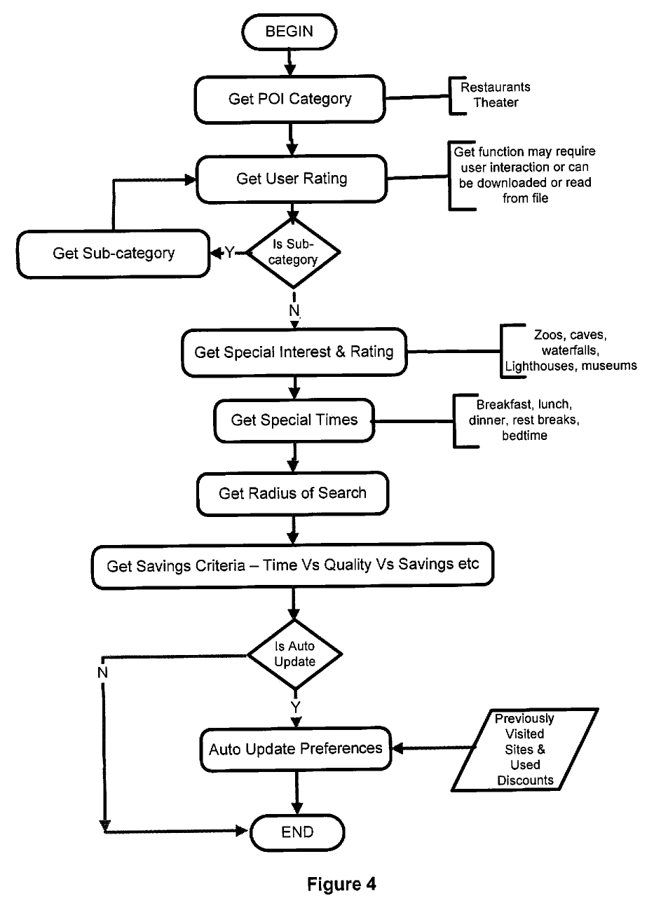

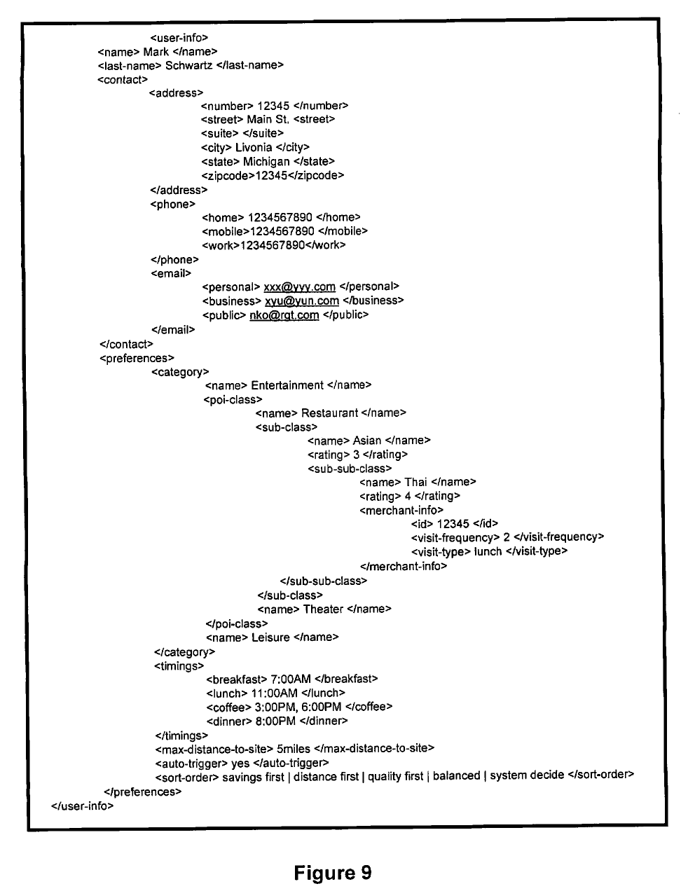

FIG. 4 is a flowchart illustrating a method of system setup to create the user preference database 80 which as shown in FIG. 3 is used by the intelligent travel guide module 30 in to make intelligent queries from the site information database 70. Creation of the user preference database 80 is a key step in setup of the ELISP system 100, as this is the database that allows the system to make personalized suggestions. The preference configuration is either performed by presenting questions to the user 110 which are answered sequentially or multiple choices are presented on a digital display screen or rendering module 50 and selections are made essentially in parallel. In alternative embodiments, the setup preferences are configured using a personal computer, or by running a web based setup procedure, wherein the configuration can be performed using pull down menus and check boxes and toggle switches. Once the preference data is captured in this fashion it is uploaded to the ELISP system 100 by using the external interface module 20. Using any of these data entry means, the group of pertinent preferences will be captured and set into the proper database format. An exemplary format for the user preference database 80 is shown in FIG. 9.

As shown in FIG. 9, preferences to be determined for capture in the user preference database 80 will include among others: (1) special times—this can include time for meals such as breakfast, lunch, dinner, snacks, intervals for rest breaks. Some early risers have breakfast at six, while others do not get up until after nine in the morning, these settings will allow the user to set the number of the meals and the range of time for them to occur. Some diets for example recommend five or six smaller meals during the day. This will lead to preferences for snacks and break times which could be scheduled in this way as well. The configuration file could be set up to understand these types of preferences. Other details would be associated with the meal number such as name for the meal, preferred cuisine (Chinese, Italian, Mexican) or for example if what is desired for that meal is a particular food type—for example coffee or tea, or bakery.

User preference settings captured in the user preference database 80 could also include (2) specialty purchases—the user 110 might be have for example a hobby such as collecting antiques or a special interest such as stamp or rare coin collecting. The configuration file captures these special shopping interests and is able to make suggestions of reasonable detours as the traveler passes within (what is probably set to be) a greater threshold distance/time of this site location.

User preference settings captured in the user preference database 80 could also include (3) special sites—if the traveler has an interest in visiting sites with unique attractions for example, a visiting a bird sanctuary would be of interest for a user 110 who has a hobby of bird watching. An animal lover may want to detour along a business trip to visit a zoo for example. All special locations such as waterfalls, lighthouses, museums, and caves will have large groups of travelers interested in being given the opportunity to make a side trip to visit that site.

User preference settings could also include (4) acceptable radii—these values would set the threshold in terms of absolute distance that would be used to filter the list of found alternatives during the search for matches to the other search criteria. The acceptable radius is set to a different value for example for one meal than another. A traveler on a business trip might need take a very fast breakfast and then get immediately to work. The same traveler might need to get back from lunch to a meeting with less detour in distance than would be acceptable at dinner time when work might already be done for the day.

User preference settings could also include (5) acceptable time delay—this sets the threshold in terms of absolute time that the projected or expected time for arrival at the previously programmed trip destination is permissibly delayed. Setting of preference values in terms of both extent of detour in distance, as well as delay in terms of time makes sure that a trip or excursion always stays on schedule.

User preference settings could also include (6) savings threshold—this is the amount in terms of monetary value or in terms of percentage savings that is used as the trigger point for requesting instant notification of availability of the savings opportunity. By setting this value in the user preferences database 80, the user 110 ensures that they are notified, the potential savings are above the value programmed for this setting, sufficiently in advance of the opportunity that they can take advantage if so desired. This setting could be set to be different for various categories of purchase. So that, for example, a savings of fifty percent on dinner might be more desirable than the same percentage savings on breakfast.

Completion of the process shown in FIG. 4 results in complete definition of the values for the structure of the user preference database 80 exemplified in FIG. 9. FIG. 9 is an exemplary data file for user preferences. When properly executed, the flowchart in FIG. 4 populates the fields of the user preference database 80.

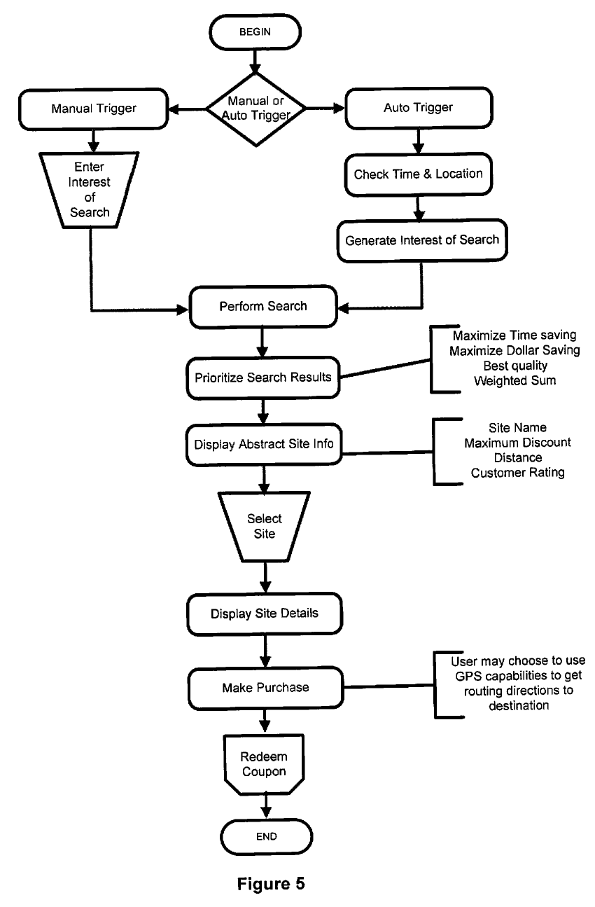

FIG. 5 is a flowchart illustrating an exemplary method for site selection within an enhanced site promotion environment. The right hand side of the FIG. 5 illustrates the site selection process when executed due to trigger by an event, milestone, or time of day, or interval of time. For example the event trigger might be breakfast, lunch, or dinner time. A milestone could for example be some fraction of the total daily trip distance. So that if the expected distance for the day were 300 miles. The software might be set to divide the trip into five segments so that every 60 miles a break is triggered. Similarly the breaks could be triggered on a time basis such that driving is interrupted every 2 hours for example. These type of triggers could also potentially avoid accidents due to excess driving fatigue. As shown in the right side of FIG. 5, the method executed by the ELISP system 100 first checks the current location and the current time. Based on the time and location values the method calculates the time to the final destination using the previously calculated trip route. Given the desired arrival time, which is previously set, the method can calculate whether a side trip will be possible without deviating to greatly from the necessary timeline. In the event that the conclusion is affirmative, or if the user has previously selected in preference settings for the ELISP system 100 to make detour suggestions, the algorithm in FIG. 5 runs within a larger repetitive loop (not shown) which attempts to make site suggestions to meet the requirements set by the preference configuration file.

For example, the system will at lunch time query the site information database 70 and identify which restaurants meet the current preference criteria. The user preference database 80 may specify that a detour for lunch time could be five miles (in any direction) while a hotel room for an overnight stay at bed time could be set to be ten miles. Depending upon the time of day, the site information database 70 is searched with the appropriate distance filter setting from the estimated location of the vehicle at the next meal time. That is, the restaurants that lie within the set radius for that meal time form a subset of possible choices which are then sorted for suitability. For example, based on user preferences, at lunch time the search engine may have a ranking of preferences such that Chinese cuisine>Italian>Thai>Japanese cuisine. With this setting ranking, if a single restaurant was found within the permissible radius for each of these cuisines then they would be listed as suggestions, with other pertinent information including discount size, in that order to the user for final selection.

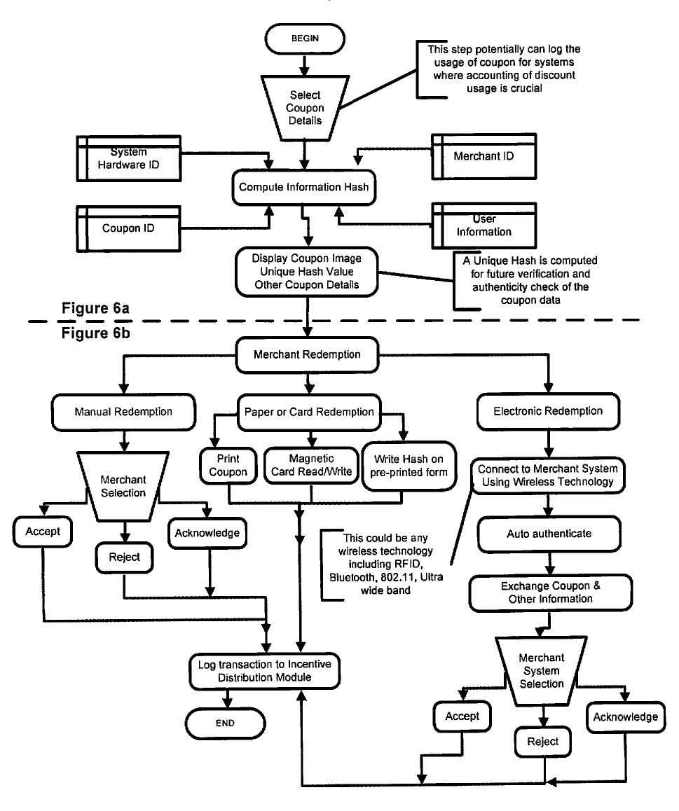

FIG. 6a is a flowchart illustrating an exemplary method of coupon generation within an enhanced site promotion environment. Once a discount offer is selected by the user 110 following the procedure shown in FIG. 5, the rendering module 50 within the ELISP system 100 constructs a specific coupon for display on the system digital display. The pertinent details such as merchant name, location, phone number and coupon value are displayed in human readable fashion and may include graphical details such as the logo of the restaurant. However, the hash computing module 40 performs a compute information hash function which combines a number of unique ID into a single unique value.

The device ID 5, is a unique value which identifies the hardware device. Likewise the merchant ID is a unique identifier contained in the site information database 70 and the user information ID is contained in the user preference database 80 or can be calculated from information contained in this database. The coupon ID is a unique value which is internally generated coupon number based on incrementing the latest value generated by the incentive utilization module 10. The hash computing module 40 combines these four unique identifiers along with time stamp information into a unique hash value which can be used in the future to uniquely identify and verify the legitimacy of the transaction.

Unlike the hashing algorithms, which only produce a one way hash value, a preferred embodiment can use a two way or reversible hashing function. The term hashing in this context refers to combining the various unique-ids into a single string that can be transformed back to its original form using a de-hashing scheme. For an example, in a very simplistic system where merchant id, coupon id and unique hardware device id 5 are represented as XXXX, YYYY, and ZZZZ respectively, a preferred embodiment can use a hashing function which combines the three numbers with a ‘-’ to generate a unique key value of XXXX-YYYY-ZZZZ.

Since all ID values are unique in this method, such a concatenation guarantees that the produced hash value is unique as well. It is clear that such hash values can be de-hashed using a simple scheme of string splitting algorithms which can split the key string at each ‘-’. While such a hashing system is not secure, it is possible to also employ encryption on a hashed string to improve the security of information. The rendering module 50 then graphically displays the coupon along with the unique computed hash value using means for graphical output.

FIG. 6b is a flowchart illustrating an exemplary method of coupon redemption within an enhanced site promotion environment. In various alternative scenarios the merchant performs a action of satisfaction to either (1) accept, (2) reject or (3) acknowledge the coupon. The incentive utilization module 10 of the ELISP system 100 as shown in FIG. 3 is responsible for keeping track of the coupon usage. It takes the user actions or merchant actions that are executed using the user interface 55 and makes adjustments to the site information database 70. In alternative embodiments the remote central server can be updated as well either directly by the incentive utilization module 10 or indirectly by mirroring the changes in the site information database 70.

In the satisfaction case of acceptance, the incentive utilization module 10 decrements the value of the remaining permitted number of uses of the accepted coupon from the site information database 70. By this method, if a coupon is intended to offer a one time promotion, the coupon will no longer be accessible or may not even appear as a hit on future searches.

In the satisfaction case of acknowledgement, the merchant 120 exercises their ability to merely allow the coupon thereby permitting the user 110 to receive a discounted price and also indicating to the ELISP system 100 that a discount is being given. However, the coupon is not removed from future availability in the site information database 70. This gives the merchant 120 and user 110 the ability to reuse the coupon or gain benefit of the same discount again.

In the satisfaction case of rejection, the merchant 120 exerts their prerogative to reject their previously established incentive. The merchant exercises their ability to not accept the coupon when they are no longer willing to extend the discount. This situation can arise upon changes in ownership of establishments and when new management has different ideas about how to promote the business.

Several means exist for redemption of the coupon value which includes among others: (1) manual redemption, (2) paper or card redemption, and (3) electronic redemption among others. The flexibility of these methods ensures that any merchant can incorporate the use of discount coupons into their merchandising procedures and thereby benefit from a low cost means for marketing and advertising.

The method with the least reliance upon technology to support retail discounts is: (1) manual redemption—in this scenario the merchant physically can look at the coupon on a display screen or in a printed form and either accept, reject, or acknowledge the coupon. The display can be either a touch screen which allows the selection to be made directly by the user or merchant contacting the appropriate portion of the screen with a finger or stylus. Alternatively selection of a choice item presented on a display by the rendering module 50 is made using an the user interface 55 which can consist of an external keyboard, an on-screen keyboard or menu, or even via a microphone to for using a voice recognition type input. In any of these alternatives it would be possible for either the user 110 or the merchant 120 or an agent of the merchant to make the actual selection.

The method which combines new technology with conventional means to support retail discounts is: (2) paper or card redemption. This instance is for those merchants that require or prefer having at least some hard copy version of the coupon for accounting and other purposes. In order to implement this alternative redemption process, the ELISP system 100 can include a small portable printer or electronically transmit a file to be printed to an external printer. Alternatively, the screen display can be of sufficient size and resolution to be captured by an imaging device which can make a duplicate screen copy. This copy of a screen image can be made via employ of hardware similar to that of a digital camera or a barcode scanning device. For screen capture purposes, the coupon display can include a barcode representation of the value calculated using a compute information hash process by the hash computing module. Capture of the barcode or unique computed has code can be done quickly and with high accuracy and thereby avoid the tediousness of writing down a long sequence of digits with high accuracy.

However, an alternative solution for paper or card based redemption is to have the merchant 120 or alternatively even the user 110 manually write down the barcode number or computed hash value on a pre-printed record form. In one embodiment, the user or merchant has preprinted blank coupon forms that can be filled in with the hash code value which would then serve the purpose of providing a paper based copy that is guaranteed not to be a forgery. The pre-printed form can even be pre-perforated in order to make

The method which makes most use of new technology to support retail discounts and thereby relies the least on user interaction is: (3) electronic redemption. This process can be followed by those merchants that have obtained some ability or have invested in the hardware necessary to electronically form a connection between the hardware of the ELISP system 100 and the external computer system of the merchant. Once communication is established between the two computer systems, a handshaking process is conducted wherein the system 100 authenticates itself. In preferred embodiment cases the communications is performed wirelessly.

Data transferred may include communication of some other information in addition to the device identification number. A public and private key based dialog can be used in a fully automated fashion using unique hardware keys to authenticate the device without any human interactions. Once authenticity has been established the ELISP system 100 and merchant computer exchange information. The merchant computer receives the electronic version of the coupon. The merchant computer may choose to ask for merchant approval for acceptance, rejection or acknowledgement of the promotion or coupon. Choice of acceptance will solicit the merchant to provide the discount on the purchase according to rules of the coupon and its face value. Such a transaction can be executed automatically upon merchant acceptance if their point-of-sale (POS) system is equipped to handle such transactions. If not, the merchant may choose to enter the discount amount manually. The data returned to the user device for the acceptance case may erase the coupon data or mark its status to be used.

The rejection use case is predominantly used by the merchant when they are offered expired coupons. Similar to paper based coupons, some merchants may choose to accept it or reject it. The rejection case may also apply to a scenario where a competing merchant wants to accept and matching their competitor's promotion. Since the user is unaware of merchant's final decision, the system may not restrict displaying such promotions or coupons. The acknowledgement use case relates to the situation where merchants do not want to delete or prevent the coupon from being reused. This allows the merchant to create repeat business based using the same data. The acknowledge use case on the merchant computer is processed similarly to the accept use case and gives the customer the required discount. However, the return message to the user device does not alter the coupon data used in the purchase for its reuse. In some special arrangements, the merchant computer can use this communication as an opportunity to provide other incentives or advertising to the customer to encourage repeat visits. The merchant computer interface in this instance is responsible for selection between the options of accepting, rejecting or acknowledging the coupon.

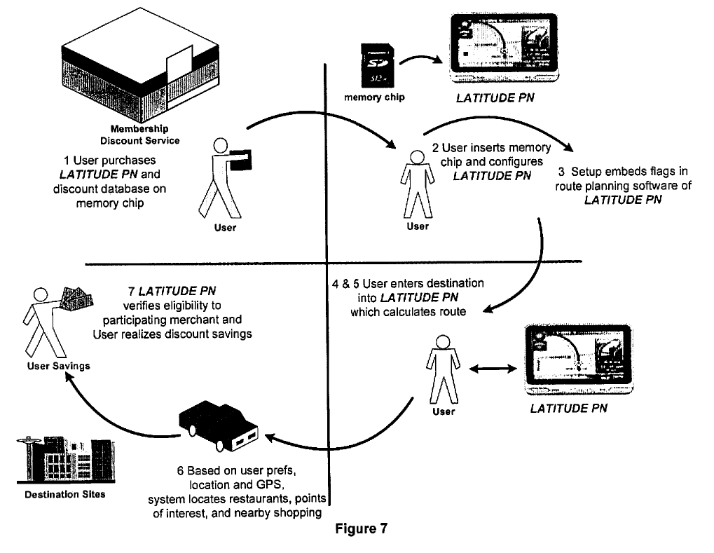

FIG. 7 is a high level system diagram illustrating usage of an exemplary system which enhances site promotion using location information and incentive distribution within a road trip environment. As shown in the FIG. 7 the trade name for this embodiment of the system of the invention is Latitudes Personal Navigator (PN). System setup as shown consists of 3 steps. (1) A user purchases membership with their favorite travel or coupon club service which then provides their regional database on a compact memory chip (2) the user inserts the chip in the memory slot on the side of LATITUDE PN whose software then automatically solicits relevant user preferences and configures this navigation software. In the final step of setup (3) LATITUDE PN setup software analyzes the user's preferences and embeds the appropriate flags in the route planning software of the personal navigation device. Travelogue and discount databases can co-exist and function together.

Also as shown in FIG. 7, during the actual LATITUDES navigation process, the user (4) enters their desired end destination(s) into the LATITUDE PN device and (5) the internal software automatically performs the route determination like conventional personal navigation devices. The new functionality comes when (6) based upon the configured preferences and current location and headings, the device makes suggestions as to which discounts will be available to the user within the preconfigured distance thresholds. Depending on time of day, the LATITUDES device can also suggest appropriate restaurants (ex. breakfast, lunch or dinner) or stops to visit including points of interest of preferred types. The user (7) proves discount eligibility to the merchant by device presentation thereby realizing immediate savings. In more advanced hardware configurations (8) the LATITUDE PN device can interface with the vehicle, and based for example upon the remaining gas tank levels, can recommend the most cost effective location to fill up on fuel.

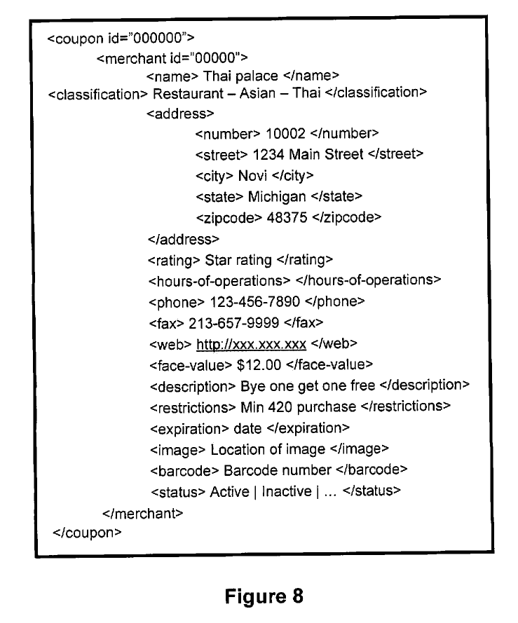

FIG. 8 shows an exemplary site information database file which assists in generating site recommendations. The database is designed to include information which makes it searchable based on user preferences. This will include location both in terms of address which can then be converted by the system to actual latitude and longitude location information using the GPS database data. This permits the search engine to locate all the points of interests (POI) around the current user location within a user specified radius. Once such POIs are retrieved, the site information database can be searched for all possible promotions available in the area. It the user has triggered a manual search, only those POIs are displayed which fall under user defined parameters with its available discounts. From very simple to very intelligent sorting functions can be employed to retrieve and sort all possible choices. A simple sorting for example may sort all possible choices based on maximization of one parameter such as savings or time or quality. A complex intelligent function may use all possible parameters along with user rating, frequency of visit, discounts, distance to commute to calculate a weighted ranking to sort the available sites.

FIG. 9 shows an exemplary predetermined user preferences database file which assists in generating site recommendations. As described in FIG. 8 this information is used to maximize user experience and savings. A manual trigger scenario is described above. In an automatic trigger, the user profile may set the system for showing various discounted sites based on timed activities that user performs on a regular basis. For example, while on a trip, due to a lunch time trigger, the system may display all eating places based on the user's preferences of luncheon places, for example a preference of Thai food for lunch. Again a complex sorting and search can be conducted to take advantage of all parameters as described earlier.

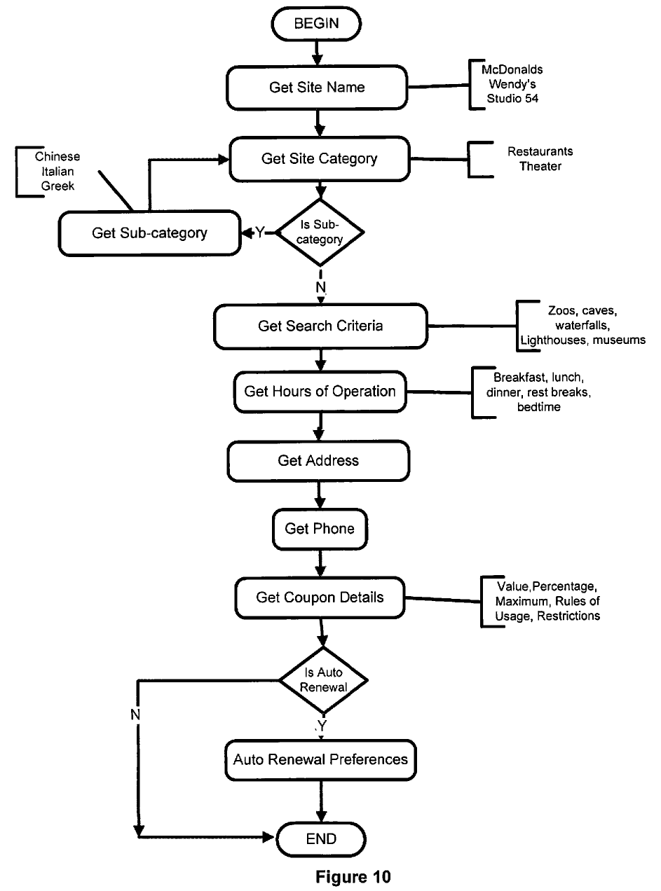

FIG. 10 is a flowchart illustrating an exemplary method used for initial ELISP system 100 setup to create the site information database files which when combined form the site information database 70. As shown in FIG. 3, the site information database 70 is used by the intelligent travel guide module 30 to make intelligent queries based on user preferences stored in the user preference database 80. As shown in FIG. 10, the merchant 120 uses a personal computer to log into a web based software application with a unique site ID. Then the software in setup mode solicits the answer to a number of questions regarding their site and their proposed discount offer to customers.

Information which is captured by the software is the desired site name for the business, the general category which may be for example restaurant, or bar, or bowling alley among others. The software can loop and pick up a number of subcategories as well such as type of restaurant cuisine. The merchant or business proprietor has the option next to add alternative key search words which are used by the intelligent travel guide module to make recommendations based on the user preferences which also include the key word picks of the user.

In order to further define the site location in terms that allow the intelligent travel guide module to make best suggestions based on time of day and location, the hours of operation and site location are captured. The phone number is also included for the user to call the merchant for example to make reservations or to order take out.

The merchant is assisted in constructing the details of the discount offer in terms of percentage discount, maximum discount, minimum purchase, ruling out of already discounted specials, exemptions for holidays among others. This is when the merchant can also specify the number of coupon uses that they want to allow each customer in terms of coupon acceptance. The ability of the merchant to acknowledge the coupon and accept it remains unaffected by the coupon use number setting. Finally for convenience the merchant has the ability to provide for auto renewal of their status in the site information database which ordinarily expires at year end.

Not shown in FIG. 10 is the alternative to offer different discounts to customers from different distances. This could allow the merchant to prevent locals from taking too frequent advantage of discounts and bring in customers that are more likely to be tourists in the area.

It is clear, based on the above teachings, that the whole financial process of merchant advertising for “brick and mortar” locations has now been essentially reversed. To further explain, using the conventional means for advertising or offering a promotion with coupons, the merchant pays a publisher to publish and/or create an advertisement. The publisher typically distributes that advert in some fashion. The customer receives the advert and presents the merchant with the valid coupon in order to execute a discounted purchase.

However, in the present embodiment, the merchant can use coupons to advertise their location or products available at their location for no advance or upfront cost to them. Merchants using the ELISP system and method participate by offering an incentive savings to customers by entering it in the Remote Central System Server 150 as shown in FIG. 3. The customers purchase ELISP systems and thereby have access to multiple discounts. When a customer makes a purchase and redeems the value of a coupon, the ELISP system transmits the value of the transaction discount to the publisher and the customer can then receive some reward or incentive for reporting from the publisher. The merchant is only charged for actual coupon usage or redemption. Therefore merchants only pay for advertising that is proven to be effective in generating a sale.

The new method and system for site promotion advertising is even more effective than the existing internet advertising wherein the merchant is charged for customer clicks because even in all variations of internet click-through advertising the merchant may be charged when the customer has not completely executed a purchase. In the present embodiment the merchant has the maximum distribution for their advertisement but only pay when it works to their advantage. Other variations of this embodiments may provide means for the merchant rather than the customer to report coupon based sales to the publisher for calculation of the charges.

Those skilled in the art can now appreciate from the foregoing description that the broad teachings of the present disclosure can be implemented in a variety of forms. Therefore, while this disclosure has been described in connection with particular examples thereof, the true scope of the disclosure should not be so limited since other modifications will become apparent to the skilled practitioner upon a study of the drawings, specification, and the following claims.

What is claimed is:

1. A system comprising: an intelligent travel guide module to determine which site information satisfies predetermined criterion; and a user interface, in communication with said intelligent travel guide module, to electronically publish said site information along with location information if it is determined by the travel guide module that the site information satisfies the predetermined criterion, said user interface to acquire the predetermined preferences from a user, and a site information database and a location determination module to provide positional data to the travel guide module to be used in the selection process.

2. The system of claim 1 wherein the location determination module is a GPS type device.

3. The system of claim 1 wherein the site information database includes promotional discount information.

4. The system of claim 1 wherein the electronic publishing of site information includes the printing or display of a discount coupon.

5. The system of claim 1 wherein the predetermined criterion includes distance preferences and the travel guide module computes distance between site location and system location for comparison to distance preferences.

6. The system of claim 1 further comprising a device identification module and unique hash computer to uniquely identify the user in claiming a discount from a site.

7. The system of claim 6 further comprising an incentive utilization module to assist in recording incentive redemption and support calculation of division of the value of the discount between the user, the service provider, and the site location among others.

8. The system of claim 7 further comprising an external interface module which provides means for communication to remote servers, a local personal computer, and the internet among others.

9. The system of claim 6 further comprising means to allow a merchant to push back new offers and discounts, incentives, or coupons to the user following the redemption process.

10. The system of claim 6 further comprising means to reverse the advertising payment process such that the merchant only pays for advertisements that generate actual sales to customers.

11. An electronic coupon apparatus comprising:
a database adapted to receive coupon information identifying individual offered coupon records each having location and date/time attributes, and having a redemption datum indicating whether the coupon is valid for redemption;
a handheld device having a user interface through which a user selects records from said database in a browse mode using at least one of said location and date/time attributes to query said database;
said user interface further implementing a presentment mode that displays presentment information pertaining to a particular coupon that the user selects to be redeemed;
a presentment mediation system coupled to said database and being operative to alter said redemption datum when said particular coupon that the user selects is redeemed;
said presentment mediation system accessing said database to enforce rules whereby redemption of said particular coupon is inhibited based on at least one of said location and date/time attributes.

12. The electronic coupon apparatus of claim 11 wherein said database includes user preference attributes and wherein said user interface implements said browse function whereby the user selects records from said database using said user preference attributes.

13. The electronic coupon apparatus of claim 11 wherein said handheld device includes a device ID unique to that device and wherein said presentment mediation system uses said device ID as part of said redemption datum.

14. The electronic coupon apparatus of claim 11 further comprising location determining module that automatically supplies an indication of the current location of the handheld device and wherein said current location is used to query said database when in said browse mode.

15. The electronic coupon apparatus of claim 11 further comprising location determining module that automatically supplies an indication of the current location of the handheld device and wherein said current location is used to query said database when in said presentment mode.

16. The electronic coupon apparatus of claim 11 wherein said redemption datum is a hash value computed in said handheld device based at least in part upon a device ID that is unique to that handheld device.

17. The electronic coupon apparatus of claim 11 further comprising navigation guide coupled to said handheld device and operative to provide navigation instructions to the user regarding where a given coupon may be redeemed.

18. The electronic coupon apparatus of claim 11 wherein said presentment mediation system includes rendering module for generating a visual image of the coupon that identifies the coupon to a merchant during redemption.

19. The electronic coupon apparatus of claim 18 further comprising printer interface coupled to said rendering module through which an image of the rendered coupon is sent to a printer.

20. The electronic coupon apparatus of claim 18 further comprising display coupled to said rendering module upon which an image of the rendered coupon is displayed during redemption.
